(19) United States
(12) Patent Application Publication
(10) Pub. No.: US 2003/0180448 A1
(43) Pub. Date: Sep. 25, 2003

(54) Method for fabrication of printed circuit boards

(75) Inventors: Edward Brook-Levinson, Petah Tikva (IL); Michael Kogan, Nesher (IL); Paikin Vacheslav, Kiryiat Haim (IL)

Correspondence Address: BROWDY AND NEIMARK, P.L.L.C., 624 NINTH STREET, NW, SUITE 300, WASHINGTON, DC, 20001-5303, US

(73) Assignee: T.L.M. ADVANCED LASER TECHNOLOGY LTD., Migdal haemek (IL)

(21) Appl. No.: 10/105,812

(22) Filed: Mar. 21, 2002

(51) Int. Cl. B05D 5/12

(52) U.S. Cl. 427/96; 427/555

(57) ABSTRACT

The present invention provides a method for the production of a patterned structure for printed circuit boards (PCBs), or intermediate layer for multilayer PCBs, comprising:

(i) providing an electrically insulating substrate;

(ii) applying electromagnetic radiation to the substrate to selectively create in said substrate vias and/or grooves and thereby produce a patterned substrate wherein the vias and/or the grooves correspond to the desired pattern of plated vias and/or conductive tracks;

(iii) applying a solution of one or more soluble metal salts, on one or both sides of the patterned substrate obtained in step (ii) so as to form, upon drying, a metal salt-based layer on the surface of the substrate and the inner surfaces of the vias and/or the grooves;

(iv) selectively irradiate said vias and/or grooves with a laser beam;

(v) removing the metal salt-based layer from the non-irradiated surfaces of one or both sides of the substrate, while leaving said layer on the inner surfaces of the laser-irradiated vias and/or grooves; and

(vi) depositing a conductive material on said vias and/or grooves inner surfaces so as to obtain an electrically insulating substrate comprising a desired pattern of plated, conductive vias and/or conductive tracks.

### FIELD OF THE INVENTION

The present invention relates to a method of printing an image on a substrate. The invention is particularly useful for producing one and two-sided printed circuit boards and also intermediate layers of multilayer printed circuit boards. It will be appreciated, however, that the invention could advantageously be used in many other applications.

### BACKGROUND OF THE INVENTION

Printed circuit boards (PCBs) are constructed of a substrate of insulating material, such as epoxy glass, having an electrically conductive pattern or net printed on one or both faces. Many techniques have been developed for printing the conductive pattern. The commonly used techniques start with a substrate having a copper layer on one or both faces. In such techniques the board is coated with a photoresist film, namely a protective film sensitive to light. The photoresist film is exposed to ultraviolet light through a phototool or mask, which is photographically constructed according to the desired pattern to be printed, producing a latent image of the pattern in the exposed areas of the photoresist film. After exposure the latent image can be developed to provide the desired resist pattern.

The foregoing techniques for producing printed circuit boards, as well as IC integrated circuit wafers or the like, thus require the preliminary preparation of the phototools. The preparation of phototools takes considerable time. The use of phototools also requires high investment in materials, machines, special environmental storage and manpower. In addition, the large number of steps, and particularly the large number involving human operations, significantly affects the yield.

Efforts are being made for developing new imaging techniques. Particularly promising are the so-called “direct imaging” techniques, employed in the production of both PCBs and printing plates. In these techniques, the exposure of selected areas of the resist film to the activating radiation needed to bring about the required changes in the film composition does not utilize a radiation source directed through a mask, but rather employs a suitably focused laser beam of appropriate wavelength light, which directly scans the resist film in a predetermined, computer-controlled, manner—see, for example, U.S. Pat. Nos. 4,724,465 and 5,895,581.

A direct-imaging technique is also described by V. M. Andreev, et al., Autometria, No. 3, 1990, pp. 102-105. This method concerns using CO₂ laser patterning, in which thermal decomposition of copper compounds occurs, to form copper particles that are consequently used as a catalytic agent for a subsequent electroless copper plating process.

### SUMMARY OF THE INVENTION

The present invention provides a simplified method for the production of printed circuit boards (PCBs), preferably double-sided PCBs, and intermediate layers for multilayer PCBs without reliance upon photosensitive materials or compositions, thus obviating the use of numerous operational steps. PCBs with high-density features, i.e. with interconnections having a width of about 5 micron or higher, typically of 25 micron width, as defined by the desired pattern, are produced by the method of the invention. This is achieved through formation of intermediate vias and reduction of the interconnection total length.

The method of the invention also enables the preparation of intermediate layers for multilayer PCBs, such layers being characterized by extremely high level of planarity. The multilayer PCBs produced by the method of the invention have reduced number of layers, weight and dimensions, resulting from improved planarity of intermediate layers and higher density of features.

Thus, the present invention provides according to an aspect thereof, a method for the production of a patterned structure for printed circuit boards (PCBs) or intermediate layers for multilayer PCBs, comprising:

(i) providing an electrically insulating substrate;

(ii) applying electromagnetic radiation to the substrate to selectively create in said substrate vias and/or grooves and thereby produce a patterned substrate, wherein the vias and/or the grooves correspond to the desired pattern of plated vias and/or conductive tracks;

(iii) applying a solution of one or more soluble metal salts, on one or both sides of the patterned substrate obtained in step (ii) so as to form, upon drying, a metal salt-based layer on the surface of the substrate and the inner surfaces of the vias and/or the grooves;

(iv) selectively irradiate said vias and/or grooves with a laser beam;

(v) removing the metal salt-based layer from the non-irradiated surfaces of one or both sides of the substrate, while leaving said layer on the inner surfaces of the laser-irradiated vias and/or grooves;

(vi) depositing a conductive material on said vias and/or grooves inner surfaces so as to obtain an electrically insulating substrate comprising a desired pattern of plated, conductive vias and/or conductive tracks.

The terms “conductive track/s”, “conductor/s”, “interconnection/s” and “connector/s” are used interchangeably.

A further aspect of the invention is provided by the printed circuit boards (PCBs) and multilayer PCBs, produced by the method of the invention.

The insulating substrates used in the method of the invention are preferably polymer sheets which are resistant to high temperatures and are normally utilized as substrates in the PCB industry. Non-limiting examples of such polymeric materials are epoxy and epoxy glass polymers, polyesters, polyimides, polystyrene, liquid crystal polymers (LCP), or fluoropolymers. In order to increase the absorption of energy supplied by the laser, the polymeric substrate may comprise various additives, for example dyes, pigments, binders and fillers.

The substrate is exposed to electromagnetic radiation, e.g. a laser beam, either through a mask capable to selectively transmit the laser beam, or scanned with a focused laser beam in a direct imaging technique, i.e. a software program drives a laser beam in a predetermined, desired manner.

The lasers used in steps (ii) and (iv) may be the same or different. Preferable lasers are those capable of producing thermal energy and of achieving high resolutions in the range of 3-5 microns, such as excimer, or Neodynium-Yag, more preferable Neodynium-Yag. For industrial-scale production of products such as PCBs, where speed of processing is of high importance, energy sources of high intensity will be preferred, such that the required transformations occur in a rapid manner.

The substrate is preferably patterned on both surfaces thereof. The vias created in step (ii) preferably have a wider diameter at the edges to provide further creation of a pad for improving adhesion of the vias coating to the polymer substrate.

The dimensions of the grooves are preferably as follows: between 3 to 200 microns width, between 1 to 50 microns thickness. The metal salt solutions used in step (iii) preferably comprise salts of metals selected from copper, nickel, silver, iron and gold, more preferably copper containing solutions. Examples of metal salts are carbonic acid and hypophosphite salts of nickel, silver, copper or gold, such as Ni(H₂O₂), HCOOAg, (HCOO)₂Cu, Cu(H₂PO₂)₂, Fe(H₂PO₂)₂, (HCOO)₂Fe, etc.

The conductive material e.g. copper or nickel, is deposited in step (vi) using either electroless chemical deposition or galvanic metal deposition techniques. In the case of electroless deposition, this technique is applied following an activating step.

The conductors produced by the method of the invention are imbedded into the substrate and are characterized by reduced length, and better impedance control through providing better tolerance (±5%) of the conductor profile deviation due to growing the conductor in a groove, which limits the conductor growth by the groove walls.

The conductors made by the method of the invention also show improved adhesion to the substrate since they are produced within grooves, where the contact area between the conductor and the substrate is provided not only at the bottom of the groove but also at its walls.

The method of the present invention provides a number of advantages, inter alia:

Higher density of features and miniaturization of PCBs due to the reduced width of the conductors;

Better uniformity of the conductor profile along its length due to growing the conductor in a groove providing that the groove walls limit the growth of the conductor in the side directions;

Better impedance control provided with high uniformity of both the groove and the conductor profile (the tolerance is provided within 5% limit compared with 15% provided with the conventional technology), which in its turn allows avoiding mushroom-like shape of the conductors typical to the conventional technologies;

Since the method imposes no limitation on the via density it allows significant reduction of the total length of the conducting pattern through forming intermediate vias and thus converting horizontal into vertical connections;

Possibility to use any polymer with high Tg (glass temperature) including fluoropolymers due to creation of the grooves and vias by laser irradiation;

Shorter processing time due to fully built electroless;

Almost perfect planarity of the PCB due to growing the conductive tracks imbedded into the substrate which provides the following advantages for multilayer PCBs:

significant reduction of the isolation layers quantity used for compacting layers into multilayer PCBs followed by respective reduction of the dimensions and weight;

reduction of the layer counts due to higher density of the interconnections;

improved technical and cost performance of PCBs due to planar circuiting.

### BRIEF DESCRIPTION OF THE DRAWINGS

FIG. 1 is a schematic representation of the basic steps of a known photolitographic method for the production of a PCB, a known direct imaging method and the method of the invention.

FIGS. 2A through 2D represent a cross section through a substrate processed by the method of the invention.

### DETAILED DESCRIPTION OF THE INVENTION

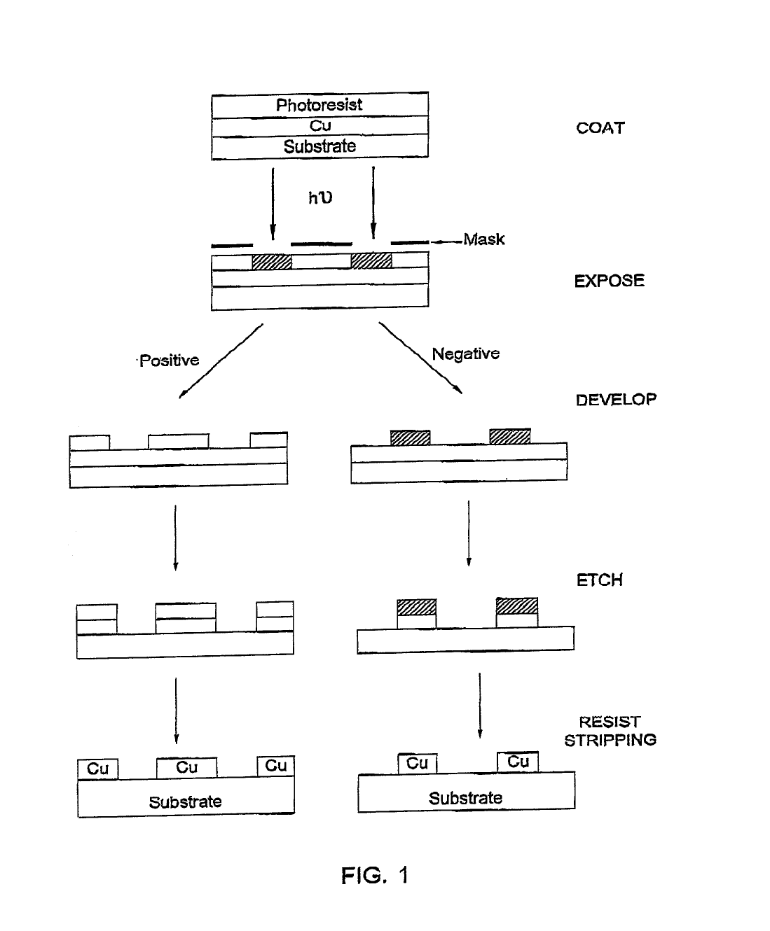

The basic steps of a known photolitographic method, of a known direct imaging method and of the method of the invention, for producing a PCB are outlined in FIG. 1. In the photolitographic method, a photoresist material is applied as a thin coating over a dielectric substrate, for example epoxy substrate, having a metal layer (e.g. cooper) covering one or both of its faces. The resist material is exposed in an imagewise fashion (through a mask) such that light strikes selected areas of the resist material. Depending upon the chemical nature of the resist material, the exposed areas may be rendered more soluble in a developing solvent than the unexposed areas, thereby producing a positive image of the mask. Conversely, the exposed areas may be rendered less soluble producing a negative image of the mask. The metal areas not protected by resist are etched down to the dielectric substrate surface, whereupon subsequent removal of the resist reveals the desired conductor pattern. Other common techniques include activation and metal deposition steps after the treatment with a developing solvent.

A traditional direct imaging technique obviates the use of a mask but still involves numerous steps that include the use of laser radiation to expose the photoresist and to activate a photochemical reaction which produces a latent image. The latent image is then developed to produce a protective layer pattern and the following steps are similar to those involved in the photolitographic method described above.

The manufacturing method in accordance with the invention has substantial advantages, inter alia: the desired conductors (grooves) and vias are produced in a single step, by laser drilling, already at the beginning of the process; high density, high resolution and high precision of the pattern formation since the conductors are engraved into the substrate and not on the surface of the substrate; short processing cycle with reduction of fabrication costs.

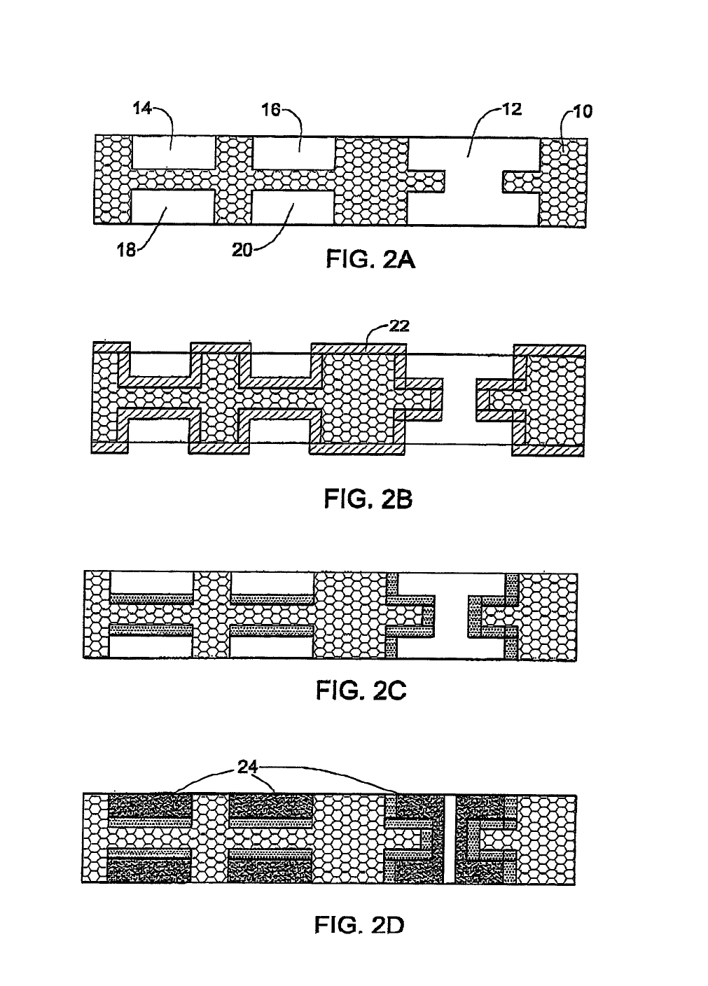

FIGS. 2A through 2D represent cross sections through a substrate processed by the method of the invention. The substrate 10 is made of an insulating material, for example polymeric materials such as epoxy and epoxy glass polymers, polyesters, polyimides, polystyrene, liquid crystal polymers (LCP), or fluoropolymers. The substrate is preferably exposed to a usual cleaning process that include washing (with water), and etching with 5% NaOH in water. After the cleaning, the substrate is exposed to a Nd- YAG laser beam either through a mask corresponding to the desired pattern of conductors and vias or scanned in a direct imaging technique using focused laser radiation. Vias 12 and grooves 14, 16, 18, 20 are produced in the substrate, as showed in FIG. 2A. The grooves and the vias are preferably made by direct imaging, using a laser beam, having a scanning velocity of 15-120 m/min. The laser beam power may be between 0.1 and 80 W.

A metal salt containing solution, e.g. copper hypophosphite (0.2-0.4 M Cu(H₂PO₂)₂) is applied, for example by spraying, dipping or spin coating, on one or both sides of the substrate patterned with vias and grooves, so as to form, upon drying, a thin (0.5 to 10 micron), uniform, metal salt-based layer 22, as indicated in FIG. 2B. The layer 22 is formed on the surface of the substrate and the inner surfaces of the vias and the grooves.

Following selective irradiation with a laser beam only in the regions that correspond to the vias and the grooves, the layer 22 is washed-out from the non-irradiated portions of the substrate, while it remains attached to the substrate in the irradiated portions that correspond to the subsequent conductors and plated vias. This selective removal of the layer 22 brings to the formation of a pattern as indicated in FIG. 2C. The layer 22 may remain on the bottom of the grooves and also on the walls (although not specifically showed in FIG. 2C). Without being bonded to the theory, it is suggested that the metal salt layer 22 undergoes, upon irradiation with the laser, thermal decomposition and subsequent complexation with the substrate material. The complex thus formed provides the base for further conductive pattern formation. It also leads to a strong adhesion of the irradiated layer 22 to the substrate.

In the next step, a conductive layer 24, e.g. copper or nickel is chemically deposited as showed in FIG. 2D, in the regions corresponding to the subsequent conductive tracks, and plated vias including the vias pads. The conductive material is deposited using either electroless chemical deposition or galvanic metal deposition techniques.

It should be mentioned that when growing the conductive track in the grooves, it may be preferable at times to grow it below the substrate surface in order to leave some space for the soldering layer. This option also improves the planarity of the PCB.

In the case of electroless deposition, this technique is applied following an activating step. Activation may be achieved by using colloidal palladium chloride composition, followed by immersion in hydrochloric acid. Copper spontaneously deposits from an electroless bath employing formaldehyde as the reducing agent. Since the reducing power of formaldehyde increases with the alkalinity of the solution, the bath is usually operated at pH above 11. An electroless coating was carried out in the method of the invention at room temperature during periods from 2 minutes to 7 hours (depending on the copper thickness required), using the following composition:

| | | |
|---|---|---|
| CuSO₄ | 10-35 | g/l |
| EDTANa₂ | 80-90 | g/l |
| NaOH | 30-40 | g/l |
| Stabilizer | 0.1-0.15 | g/l |
| Formaldehyde | 20-25 | ml/l |

| | |
|---|---|
| pH | 12.6-12.8 |

The dimensions of the conductors obtained by the method were: thickness: 0.5-30 microns; width: 5-200 microns.

U.S. Pat. Nos. 4,279,948, 6,042,889 and 4,209,331 disclose further methods and compositions for electroless deposition.

Compositions and methods using electroless nickel, both acid and alkaline types, are well documented in the prior art, for example in U.S. Pat. No. 3,832,168.

As mentioned above, the conductive layer may be deposited also by electroplating. Upon electroless plating, the conductor pattern could be further fortified by regular galvanoplating. The composition and method covered in U.S. Pat. No. 4,619,741, is indicative of one such approach.

The process described above has been employed to produce patterns with resolution of min 3-5 micron.

1. A method for the production of a patterned structure for printed circuit boards (PCBs), or intermediate layer for multilayer PCBs, comprising:
(i) providing an electrically insulating substrate;
(ii) applying electromagnetic radiation to the substrate to selectively create in said substrate vias and/or grooves and thereby produce a patterned substrate, wherein the vias and/or the grooves correspond to the desired pattern of plated vias and/or conductive tracks;
(iii) applying a solution of one or more soluble metal salts, on one or both sides of the patterned substrate obtained in step (ii) so as to form, upon drying, a metal salt-based layer on the surface of the substrate and the inner surfaces of the vias and/or the grooves;
(iv) selectively irradiate said vias and/or grooves with a laser beam;
(v) removing the metal salt-based layer from the non-irradiated surfaces of one or both sides of the substrate, while leaving said layer on the inner surfaces of the laser-irradiated vias and/or grooves; and
(vi) depositing a conductive material on said vias and/or grooves inner surfaces so as to obtain an electrically insulating substrate comprising a desired pattern of plated, conductive vias and/or conductive tracks.

2. The method of claim 1, wherein said metal is selected from copper, nickel, silver, iron and gold.

3. The method of claim 1 wherein said conductive material is deposited in step (vi) using electroless chemical deposition or galvanic metal deposition.

4. The method of claim 3, wherein said conductive material is applied using electroless chemical deposition, following an activating step.

5. The method of claim 1, wherein step (ii) is carried out with a Nd-YAG laser.

6. The method of claim 1, wherein step (iv) is carried out with a Nd-YAG laser.

7. The method of claim 1, wherein said metal salt is a metal hypophosphite salt.

8. The method of claim 1 further comprising a cleaning step after step (i), such cleaning comprising washing, degreasing and etching of the substrate.

9. A printed circuit board comprising at least one patterned structure produced by the method of claim 1.

10. A double-sided printed circuit board comprising at least one patterned structure produced by the method of claim 1.

11. An intermediate layer for multilayer printed circuit board comprising at least one patterned structure produced by the method of claim 1.

12. A multilayer printed circuit board comprising a plurality of patterned structures produced by the method of claim 1
